(19) United States
(12) Patent Application Publication
(10) Pub. No.: US 2016/0023241 A1
(43) Pub. Date: Jan. 28, 2016

(54) PHOTOLUMINESCENT NANO COMPOSITE MATERIAL AND METHOD OF FABRICATING THE SAME

(71) Applicant: National Taiwan University, Taipei (TW)

(72) Inventors: Huan-Tsung Chang, Taipei (TW); Po-Cheng Chen, Taipei City (TW); Chung-Chien Shih, Tainan City (TW)

(21) Appl. No.: 14/477,880

(22) Filed: Sep. 5, 2014

(30) Foreign Application Priority Data
Jun. 11, 2014 (TW) 103120207

(51) Int. Cl. B05D 3/00

(52) U.S. Cl. CPC B05D 3/007; Y10S 977/774; Y10S 977/896; Y10S 977/892; Y10S 977/95; B82Y 40/00

(57) ABSTRACT

Provided is a photoluminescent nano composite material including a plurality of silicon oxide clusters and a plurality of carbon nanostructures. The carbon nanostructures are embedded in the silicon oxide clusters, wherein the carbon nanostructures generate an emitted light upon irradiation of an excitation light source.

### CROSS-REFERENCE TO RELATED APPLICATION

This application claims the priority benefit of Taiwan application serial no. 103120207, filed on Jun. 11, 2014. The entirety of the above-mentioned patent application is hereby incorporated by reference herein and made a part of this specification.

### BACKGROUND OF THE INVENTION

1. Field of the Invention

The invention relates to a nanomaterial and a method of fabricating the same. More particularly, the invention relates to a photoluminescent nano composite material and a method of fabricating the same.

2. Description of Related Art

With the rapid development of modern technology, all products are desired to be slim and light. As a result, the level of research of miniaturized materials has also increased. In the past, the research materials were mostly micron-grade, and in recent years, nanoscale materials have become the focus. When the particle size of a material is reduced to nanoscale, the behavior and characteristics exhibited by the material are different from those of a macroscopic material, and influence of surface effect and quantum confinement effect on the material need to be considered. When the particle size gradually approaches the atomic scale, the number of surface atoms, specific surface area, and surface energy thereof all increase rapidly. As a result, the number and effects of surface atoms cannot be ignored. Since surface atoms are increased, the coordination number of surrounding atoms is insufficient and the surface energy is high. As a result, the surface atoms have very high chemical activity. At this point, unique characteristics of for instance, optics, electromagnetism, adsorption, and catalysis may result.

Currently, there are many types of luminescent nanomaterials such as metal nanomaterials, semiconductor quantum dots, and non-metallic organic nanomaterials, wherein different materials have different functions and characteristics. Graphene quantum dots are also referred to as carbon dots, and in the past decade have generated wide attention, mainly due to graphene having a unique structure and having superior thermal conduction, optics, electrical properties, mechanical properties, surface modifiability, and good biocompatibility. In particular, characteristics of photoluminescence and electro-catalytic activity of the graphene quantum dots are of particular interest.

Although graphene quantum dots have excellent application in many fields, many issues still need to be solved. In particular, the most important issue is: absorption of most graphene quantum dots in the visible light region is low such that photoluminescence of the graphene quantum dots mainly falls within the blue light region (UV excitation). As a result, application in white light optoelectronic displays, bioluminescence imaging, and bioassays is limited. Therefore, the development of a fabrication method for synthesizing large quantities of graphene quantum dots for which luminescence wavelength can be regulated and increasing the luminescence quantum yield and the chemical and optical stability thereof in solid state are relatively important topics.

### SUMMARY OF THE INVENTION

The invention provides a photoluminescent nano composite material and a method of fabricating the same. The method is capable of synthesizing a nano composite material powder or thin film for which luminescence wavelength can be regulated.

The photoluminescent nano composite material of the invention includes a plurality of silicon oxide clusters and a plurality of carbon nanostructures. The carbon nanostructures are embedded in the silicon oxide clusters, wherein the carbon nanostructures generate an emitted light upon irradiation of an excitation light source.

In an embodiment of the invention, the size of the carbon nanostructures is 6.5 nm to 7.7 nm.

In an embodiment of the invention, the wavelength range of the excitation light source is 360 nm to 520 nm and the wavelength range of the emitted light is 455 nm to 637 nm.

In an embodiment of the invention, the size of the carbon nanostructures is 12.4 nm to 14 nm.

In an embodiment of the invention, the wavelength range of the excitation light source is 360 nm to 520 nm and the wavelength range of the emitted light is 534 nm to 645 nm.

In an embodiment of the invention, the size of the carbon nanostructures is 25 nm to 31 nm.

In an embodiment of the invention, the wavelength range of the excitation light source is 360 nm to 520 nm and the wavelength range of the emitted light is 574 nm to 659 nm.

In an embodiment of the invention, the carbon nanostructures include graphene quantum dots.

The invention provides a method of fabricating a photoluminescent nano composite material including the following steps.

Step (A): an organosilane solution is provided.

Step (B): a first heat treatment is performed on the organosilane solution with a hydrothermal method to form a nano composite material precursor solution.

Step (C): a hydrolysis condensation reaction and a drying treatment are performed on the nano composite material precursor solution to form a first nano composite material powder.

In an embodiment of the invention, the steps of the hydrolysis condensation reaction include diluting the nano composite material precursor solution 45 folds to 50 folds with double distilled water and then leaving the solution in an incubator at 30° C. to 35° C. for 12 hours to 14 hours.

In an embodiment of the invention, after step (C), step (D) is further included: a second heat treatment is performed on the first nano composite material powder to form a second nano composite material powder.

In an embodiment of the invention, the temperature of the second heat treatment is 300° C. to 322° C. and the heating time of the second heat treatment is 10 minutes to 12 minutes.

In an embodiment of the invention, the temperature of the second heat treatment is 300° C. to 322° C. and the heating time of the second heat treatment is 20 minutes to 22 minutes.

In an embodiment of the invention, the organosilane solution includes: an aqueous solution of 3-aminopropyl trimethoxysilane (APTMS) or an aqueous solution of 3-aminopropyl triethoxysilane.

In an embodiment of the invention, the temperature of the first heat treatment is 300° C. to 315° C. and the heating time of the first heat treatment is 2 hours to 2.15 hours.

The invention further provides a method of fabricating a photoluminescent nano composite material including the following steps.

Step (A): an organosilane solution is provided.

Step (B): a first heat treatment is performed on the organosilane solution with a hydrothermal method to form a nano composite material precursor solution.

Step (C): a substrate is placed in the nano composite material precursor solution such that a hydrolysis condensation reaction is performed on a surface of the substrate by the nano composite material precursor solution and a thin film is formed on the surface of the substrate.

Step (D): a drying treatment is performed on the thin film to form a first nano composite material thin film.

In an embodiment of the invention, the steps of the hydrolysis condensation reaction include diluting the nano composite material precursor solution 45 folds to 50 folds with double distilled water. A substrate is placed in the nano composite material precursor solution, and the surface of the substrate on which a film is to be grown is faced up. The substrate is left in an incubator at 30° C. to 35° C. for 12 hours to 14 hours such that a thin film is formed on the surface of the substrate.

In an embodiment of the invention, after step (D), step (E) is further included: a second heat treatment is performed on the first nano composite material thin film to form a second nano composite material thin film.

In an embodiment of the invention, the temperature of the second heat treatment is 300° C. to 322° C. and the heating time of the second heat treatment is 10 minutes to 12 minutes.

In an embodiment of the invention, the temperature of the second heat treatment is 300° C. to 322° C. and the heating time of the second heat treatment is 20 minutes to 22 minutes.

In an embodiment of the invention, the organosilane solution includes: an aqueous solution of 3-aminopropyl trimethoxysilane or an aqueous solution of 3-aminopropyl triethoxysilane.

In an embodiment of the invention, the temperature of the first heat treatment is 300° C. to 310° C. and the heating time of the first heat treatment is 2 hours to 2.15 hours.

Based on the above, the invention provides a fabrication method combining a hydrothermal method and a heating method to synthesize a nano composite material powder or thin film for which luminescence wavelength can be regulated. The fabrication method has the advantages of safe operation, fast and easy, low toxicity, environmentally-friendly, simple setup, and safe, low-cost, and readily obtainable raw materials. The nano composite material powder or thin film formed thereby has superior characteristics in, for instance, luminescence intensity, wavelength-regulative luminescence qualities, good optical and chemical stability, high catalysis, and ready modification on a glass substrate. As a result, the nano composite material powder or thin film can be applied in an optical display (such as a white light LED), lithography, the cathode material of a fuel cell, and stained glass.

In order to make the aforementioned features and advantages of the disclosure more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a photoluminescent nano composite material of the invention.

FIG. 2A is a high-resolution transmission electron microscopy (HR-TEM) micrograph of a graphene quantum dot powder of experimental example 1.

FIG. 2B is a partial enlarged view of FIG. 2A.

FIG. 3A is a HR-TEM micrograph of a graphene quantum dot powder of experimental example 2.

FIG. 3B is a partial enlarged view of FIG. 3A.

FIG. 4A is a HR-TEM micrograph of a graphene quantum dot powder of experimental example 3.

FIG. 4B is a partial enlarged view of FIG. 4A.

FIG. 5A to FIG. 5C are fluorescence spectrograms of graphene quantum dot powders of experimental examples 1, 2, and 3 under excitation lights of different wavelengths.

FIG. 6 is a relationship diagram of current density-potential variation of graphene quantum dot powders of experimental examples 1 to 3 and a fluorescent graphene quantum dot solution of comparative example 1 measured by cyclic voltammetry.

FIG. 7 is a picture of graphene quantum dot powders of experimental examples 1 to 3 and a fluorescent graphene quantum dot solution of comparative example 1 after an electrode stability test.

### DESCRIPTION OF THE EMBODIMENTS

In the present specification, ranges represented by “a numerical value to another numerical value” are schematic representations to avoid listing all of the numerical values in the range in the specification. Therefore, the recitation of a specific numerical range discloses any numerical value in the numerical range and a smaller numerical range defined by any numerical value in the numerical range, as is the case with any numerical value and a smaller numerical range stated expressly in the specification. For instance, the range of “a size of 100 nm to 500 nm” discloses the range of “a size of 200 nm to 350 nm”, regardless of whether other numerical values are listed in the specification.

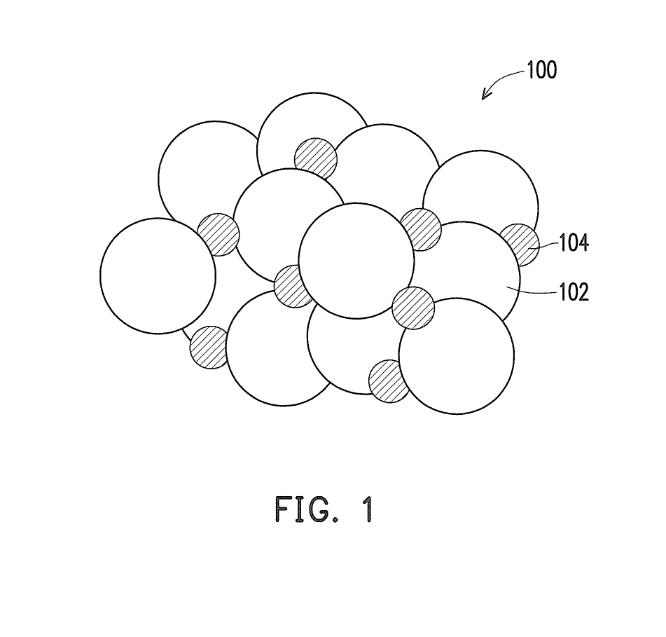

One aspect of the invention provides a photoluminescent nano composite material. The structure thereof is as shown in FIG. 1.

Referring to FIG. 1, a photoluminescent nano composite material 100 includes a plurality of silicon oxide clusters 102 and a plurality of carbon nanostructures 104. The carbon nanostructures 104 are each embedded in the silicon oxide clusters 102, wherein each carbon nanostructure 104 can generate an emitted light upon irradiation of an excitation light source. In an embodiment, the material of the carbon nanostructures 104 can include zero-dimensional nanostructures. In an embodiment, the material of the carbon nanostructures 104 can include graphene quantum dots.

The nano composite material 100 can exist in the form of a powder or a thin film. In the following, methods of fabricating different forms of the nano composite material 100 are described.

The first embodiment of the invention provides a method of fabricating a powder of the nano composite material 100 including the following steps. First, an organosilane solution is provided. The organosilane solution can be a solution formed by dissolving silane in an organic or non-organic solvent, wherein the silane contains at least one carbon atom, and is, for instance, a silane having an alkoxy group. In an embodiment, the organosilane solution includes an aqueous solution of 3-aminopropyl trimethoxysilane (APTMS) or an aqueous solution of 3-aminopropyl triethoxysilane. Then, a first heat treatment is performed on the organosilane solution with a hydrothermal method. During this period, the high temperature makes the organosilane go through treatments of dehydration, polymerization, carbonization, and passivation such that a nano composite material precursor solution is formed. Specifically, first of all, a first heat treatment is performed on the organosilane solution, and then impurities and larger precipitates are removed via centrifugation. After the supernatant is taken out, a second heating (such as a calcination treatment) is performed with the conditions of the first heat treatment. After further being purified by centrifugation, the nano composite material precursor solution can be obtained. In an embodiment, the temperature of the first heat treatment is 300° C. to 310° C. and the heating time of the first heat treatment is 2 hours to 2.15 hours. Under such heating conditions, the size of the obtained carbon nanostructures 104 is 1 nm to 5 nm. When the carbon nanostructures 104 absorb an excitation light having a wavelength range of 360 nm to 520 nm, the carbon nanostructures 104 emit light having a wavelength range of 432 nm to 570 nm.

Next, a hydrolysis condensation reaction and a drying treatment are further performed to form a first nano composite material powder. Specifically, the steps of the hydrolysis condensation reaction include diluting the nano composite material precursor solution 45 folds to 50 folds with double distilled water and then leaving the solution in an incubator at 30° C. to 35° C. for 12 hours to 14 hours. A white precipitate is thus obtained. Then, purification by centrifugation is further performed twice, and then the white precipitate in the lower layer is placed in an oven at 60° C. to 65° C. for 60 minutes to 80 minutes to perform a drying treatment. The first nano composite material powder is thus obtained. In the first embodiment, the size of the carbon nanostructures 104 in the first nano composite material powder is 6.5 nm to 7.7 nm. When the carbon nanostructures 104 absorb an excitation light having a wavelength range of 360 nm to 520 nm, the carbon nanostructures 104 emit light having a wavelength range of 455 nm to 637 nm.

Since the ordinary synthetic fluorescent carbon nanomaterial is generally in a solution form, after being dried to powder form, the nanomaterial aggregates such that the photoluminescence characteristics thereof are removed. As a result, the development thereof in the optoelectronics industry is limited. However, the method of fabricating a powder of the nano composite material 100 of the invention can solve the above issue such that the formed first nano composite material powder still has photoluminescence characteristics.

The second embodiment of the invention provides a method of fabricating a powder of the nano composite material 100 including the following steps. First, a first nano composite material powder is prepared with the same method as the first embodiment. Then, a second heat treatment is performed on the first nano composite material powder to form a second nano composite material powder. In the second embodiment, the size of the carbon nanostructures 104 in the second nano composite material powder is 12.2 nm to 14 nm. When the carbon nanostructures 104 absorb an excitation light having a wavelength range of 360 nm to 520 nm, the carbon nanostructures 104 emit light having a wavelength range of 534 nm to 645 nm. In an embodiment, the second heat treatment can include a calcination treatment, the temperature of the second heat treatment is 300° C. to 322° C., and the heating time of the second heat treatment is 10 minutes to 12 minutes.

The third embodiment of the invention provides a method of fabricating a powder of the nano composite material 100 including the following steps. First, a first nano composite material powder is prepared with the same method as the first embodiment. Then, a third heat treatment is performed on the first nano composite material powder to form a third nano composite material powder. In the third embodiment, the size of the carbon nanostructures 104 in the third nano composite material powder is 25 nm to 31 nm. When the carbon nanostructures 104 absorb an excitation light having a wavelength range of 360 nm to 520 nm, the carbon nanostructures 104 emit light having a wavelength range of 574 nm to 659 nm. In an embodiment, the third heat treatment can include a calcination treatment, the temperature of the third heat treatment is 300° C. to 322° C., and the heating time of the third heat treatment is 20 minutes to 22 minutes.

When the time of the heat treatment is increased, the particle size of the nano composite material 100 is increased as a result, and the luminescence wavelength thereof is also increased. Therefore, in the invention, calcination can be performed using different heat treatment conditions such that the particle size of the formed nano composite material 100 is different, thereby generating different luminescence wavelengths. As a result, by changing the particle size of the nano composite material 100, the luminescence wavelength thereof can be regulated, such that the nano composite material of the invention can be effectively applied in fields such as white light optoelectronic display, bioluminescence imaging, and bioassay.

The fourth embodiment of the invention provides a method of fabricating a thin film of the nano composite material 100 including the following steps. First, a nano composite material precursor solution is prepared with the same method as the first embodiment. Then, a hydrolysis condensation reaction is performed on a surface of the substrate by the nano composite material precursor solution and a thin film is formed on the surface of the substrate. Specifically, the steps of the hydrolysis condensation reaction include diluting the nano composite material precursor solution 45 folds to 50 folds with double distilled water, then parallelly immersing a substrate (such as a glass substrate) in the above solution, placing the surface of the substrate on which a film is to be grown face up, and then leaving the substrate in an incubator at 30° C. to 35° C. for 12 hours to 14 hours. A thin film is thereby generated on the surface of the substrate facing up. The prepared thin film is further dried in an oven at 60° C. to 65° C. for 60 minutes to 80 minutes, thereby obtaining a first nano composite material thin film. In the fourth embodiment, the size of the carbon nanostructures 104 in the first nano composite material thin film is 6.5 nm to 7.7 nm. When the carbon nanostructures 104 absorb an excitation light having a wavelength range of 360 nm to 520 nm, the carbon nanostructures 104 emit light having a wavelength range of 455 nm to 637 nm. Since the nano composite material of the invention contains a silicon functional group, the material can be readily modified on a glass substrate and is not readily peeled off In this way, the nano composite material thin film of the invention can be used as the cathode material of an electrode and thereby solve the issues of readily peeled off and poor stability of the ordinary cathode material.

The fifth embodiment of the invention provides a method of fabricating a thin film of the nano composite material 100 including the following steps. First, a first nano composite material thin film is prepared with the same method as the fourth embodiment. Then, a second heat treatment is performed on the first nano composite material thin film to form a second nano composite material thin film. In the fifth embodiment, the size of the carbon nanostructures 104 in the second nano composite material thin film is 12.4 nm to 14 nm. When the carbon nanostructures 104 absorb an excitation light having a wavelength range of 360 nm to 520 nm, the carbon nanostructures 104 emit light having a wavelength range of 534 nm to 645 nm. In an embodiment, the second heat treatment can include a calcination treatment, the temperature of the second heat treatment is 300° C. to 322° C., and the heating time of the second heat treatment is 10 minutes to 12 minutes.

The sixth embodiment of the invention provides a method of fabricating a thin film of the nano composite material 100 including the following steps. First, a first nano composite material thin film is prepared with the same method as the fourth embodiment. Then, a third heat treatment is performed on the first nano composite material thin film to form a third nano composite material thin film. In the sixth embodiment, the size of the carbon nanostructures 104 in the third nano composite material thin film is 25 nm to 31 nm. When the carbon nanostructures 104 absorb an excitation light having a wavelength range of 360 nm to 520 nm, the carbon nanostructures 104 emit light having a wavelength range of 574 nm to 659 nm. In an embodiment, the third heat treatment can include a calcination treatment, the temperature of the third heat treatment is 300° C. to 322° C., and the heating time of the third heat treatment is 20 minutes to 22 minutes. In the invention, calcination can be performed using different heat treatment conditions such that the particle size of the formed nano composite material 100 is different, thereby generating different luminescence wavelengths. As a result, by changing the particle size of the nano composite material 100, the luminescence wavelength thereof can be regulated, such that the nano composite material of the invention can be effectively applied in fields such as white light optoelectronic display, bioluminescence imaging, and bioassay.

<Experiments>

To demonstrate that the invention can be realized, the following experimental examples are cited to describe the invention more specifically. Although the following experiments are described, the materials used and the amount and ratio thereof, as well as handling details and handling process . . . etc., can be modified without exceeding the scope of the invention. Accordingly, restrictive interpretation should not be made to the invention based on the experiments described below.

### COMPARATIVE EXAMPLE 1

### Fabrication of Fluorescent Graphene Quantum Dot Solution

5.7 M of a 3-aminopropyl trimethoxysilane (APTMS, made by Aldrich Co., Ltd.) solution was made into 1 M of an aqueous solution of APTMS via deionized water, wherein the aqueous solution was exothermic during the process. After the aqueous solution was left to cool, 15 mL of the 1 M aqueous solution of APTMS was placed in a Teflon cup (outside diameter: 4.6 cm, inside diameter: 4.15 cm, inside height: 5.2 cm, outside height: 5.5 cm) and a lid (thickness: 0.3 cm) was added. Then, the Teflon cup with the aqueous solution was placed in a stainless calcination cup and the stainless calcination cup was sealed tight. Next, the stainless calcination cup was placed in a high-temperature calcination furnace, and the temperature of the high-temperature calcination furnace was raised to 300° C. within 20 minutes. The stainless calcination cup was then calcinated at 300° C. for 2 hours. After being left to cool, impurities and precipitates were removed via high-speed centrifugation (1006 g, 3000 rpm, 10 minutes). Then, the supernatant was taken out, and a second calcination was performed with the same conditions. After purification was performed via centrifugation (1006 g, 3000 rpm, 10 minutes), a light yellow transparent fluorescent graphene quantum dot solution having a quantum yield of 42% was obtained.

$${Q}_{C \text{-} dot} = \frac{{Q}_{R} \times {I}_{C \text{-} dot} \times {Abs}_{R} \times {n}_{C \text{-} dot}^{2}}{{I}_{R} \times {Abs}_{C \text{-} dot} \times {n}_{R}^{2}}$$

Formula of quantum yield:

Q_{C-dot}=C-dot quantum yield, Q_{R}=standard quantum yield, I_{C-dot}=C-dot fluorescence integrated intensity, Abs_{R}=standard absorbance, n_{C-dot}=C-dot index of refraction, I_{R}=standard fluorescence integrated intensity, Abs_{C-dot}=C-dot absorbance, n_{R}=standard index of refraction.

### EXPERIMENTAL EXAMPLE 1

### Fabrication of Graphene Quantum Dot Powder

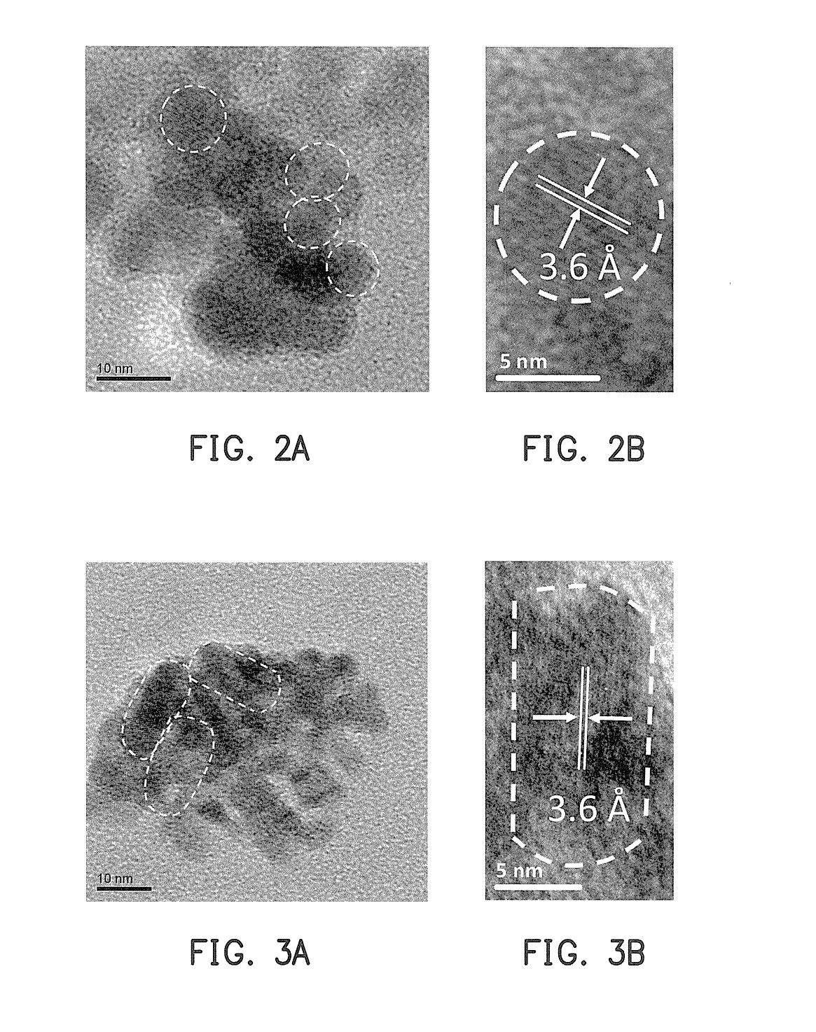

First, a graphene quantum dot solution was prepared with the same method as comparative example 1. Then, after the graphene quantum dot solution of comparative example 1 was diluted 50 folds with double distilled water, the graphene quantum dot solution of comparative example 1 was left in an incubator at 30° C. for 12 hours. A white precipitate was thus obtained, and after high-speed centrifugation (1006 g, 3000 rpm, 10 minutes) was performed, the supernatant was taken out. Redissolution was then performed with 15 mL of deionized water, and then cleaning via purification was performed twice. Lastly, after centrifugation (1006 g, 3000 rpm, 10 minutes), the white precipitate in the lower layer was taken out and placed in an oven at 60° C. for 60 minutes to dry, thereby obtaining the graphene quantum dot powder of experimental example 1. An analysis with an energy-dispersive spectroscope shows that the powder has the elements of carbon, oxygen, nitrogen, and silicon. Blue light (450 nm to 475 nm) was emitted by the powder upon irradiation of an ultraviolet lamp (360 nm to 380 nm), and the particle size thereof was verified to be 7.1±0.6 nm (as shown in FIG. 2A) by HR-TEM. FIG. 2B is a partial enlarged diagram of an HR-TEM micrograph of the graphene quantum dot powder of experimental example 1. In FIG. 2A and FIG. 2B, the portion labeled with a white dashed frame is the atomic lattice spacing of the graphite, i.e., the layer spacing of the graphite, and the spacing thereof is 3.6 Å. In other words, the spacing region corresponds to the carbon nanostructures 104 of FIG. 1, which is the “graphene quantum dots” described above; and the other portions in the figure correspond to the silicon oxide clusters 102 of FIG. 1.

### EXPERIMENTAL EXAMPLE 2

### Fabrication of Graphene Quantum Dot Powder

First, a graphene quantum dot powder was prepared with the same method as experimental example 1. Then, the graphene quantum dot powder of experimental example 1 was placed in a lidless quartz crucible and calcinated with a high-temperature calcination furnace at 300° C. for 10 minutes. After being cooled at room temperature, the graphene quantum dot powder of experimental example 2 was obtained. An analysis with an energy-dispersive spectroscope shows that the powder has the elements of carbon, oxygen, nitrogen, and silicon. Green light (525 nm to 550 nm) was emitted by the powder upon irradiation of an ultraviolet lamp (360 nm to 380 nm), and the particle size thereof was verified to be 13.2±0.8 nm (as shown in FIG. 3A) by HR-TEM. FIG. 3B is a partial enlarged diagram of an HR-TEM micrograph of the graphene quantum dot powder of experimental example 2. In FIG. 3A and FIG. 3B, the portion labeled with a white dashed frame is the atomic lattice spacing of the graphite, i.e., the layer spacing of the graphite, and the spacing thereof is 3.6 Å. In other words, the spacing region corresponds to the carbon nanostructures 104 of FIG. 1, which is the “graphene quantum dots” described above; and the other portions in the figure correspond to the silicon oxide clusters 102 of FIG. 1.

### EXPERIMENTAL EXAMPLE 3

### Fabrication of Graphene Quantum Dot Powder

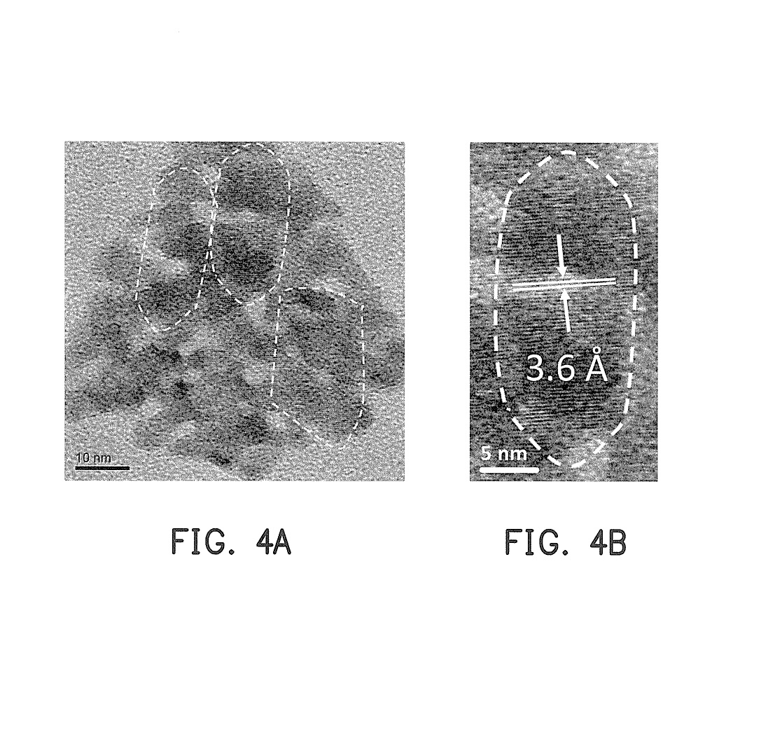

First, a graphene quantum dot powder was prepared with the same method as experimental example 1. Then, the graphene quantum dot powder of experimental example 1 was placed in a lidless quartz crucible and calcinated with a high-temperature calcination furnace at 300° C. for 20 minutes. After being cooled at room temperature, the graphene quantum dot powder of experimental example 3 was obtained. An analysis with an energy-dispersive spectroscope shows that the powder has the elements of carbon, oxygen, nitrogen, and silicon. Yellow light (570 nm to 590 nm) was emitted by the powder upon irradiation of an ultraviolet lamp (360 nm to 380 nm), and the particle size thereof was verified to be 28+3 nm (as shown in FIG. 4A) by HR-TEM. FIG. 4B is a partial enlarged diagram of an HR-TEM micrograph of the graphene quantum dot powder of experimental example 3. In FIG. 4A and FIG. 4B, the portion labeled with a white dashed frame is the atomic lattice spacing of the graphite, i.e., the layer spacing of the graphite, and the spacing thereof is 3.6 Å. In other words, the spacing region corresponds to the carbon nanostructures 104 of FIG. 1, which is the “graphene quantum dots” described above; and the other portions in the figure correspond to the silicon oxide clusters 102 of FIG. 1.

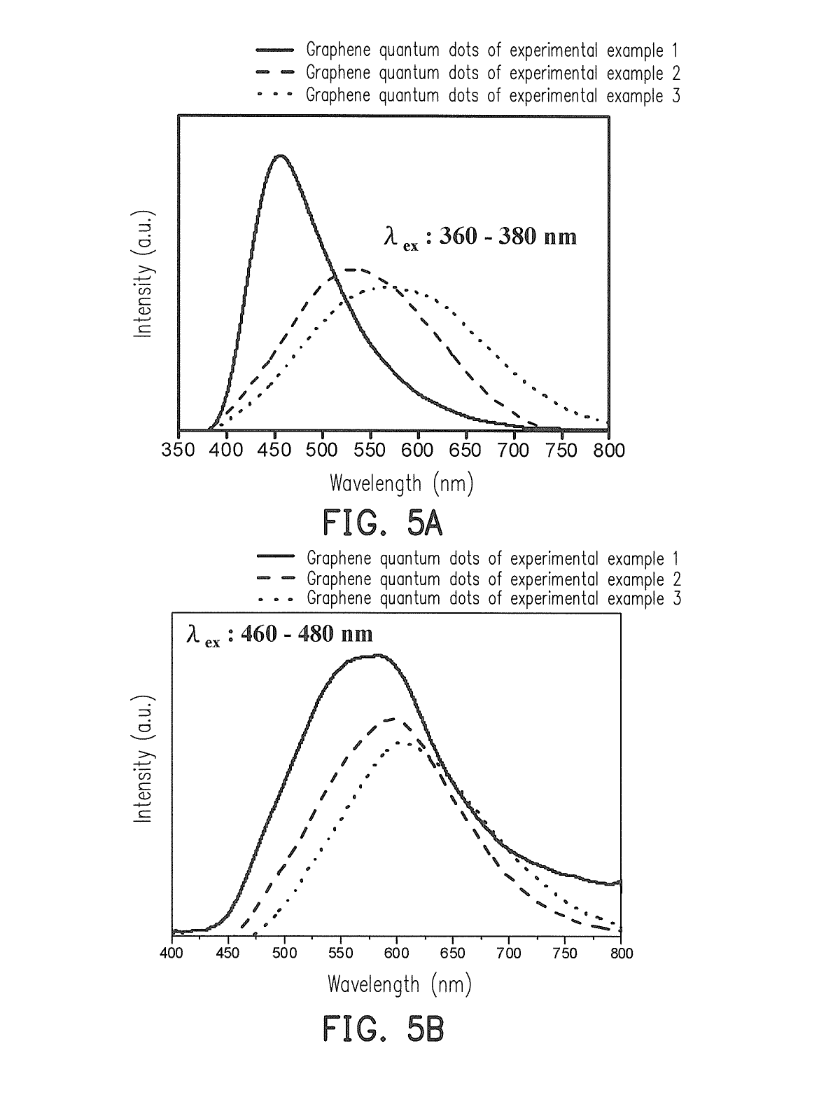

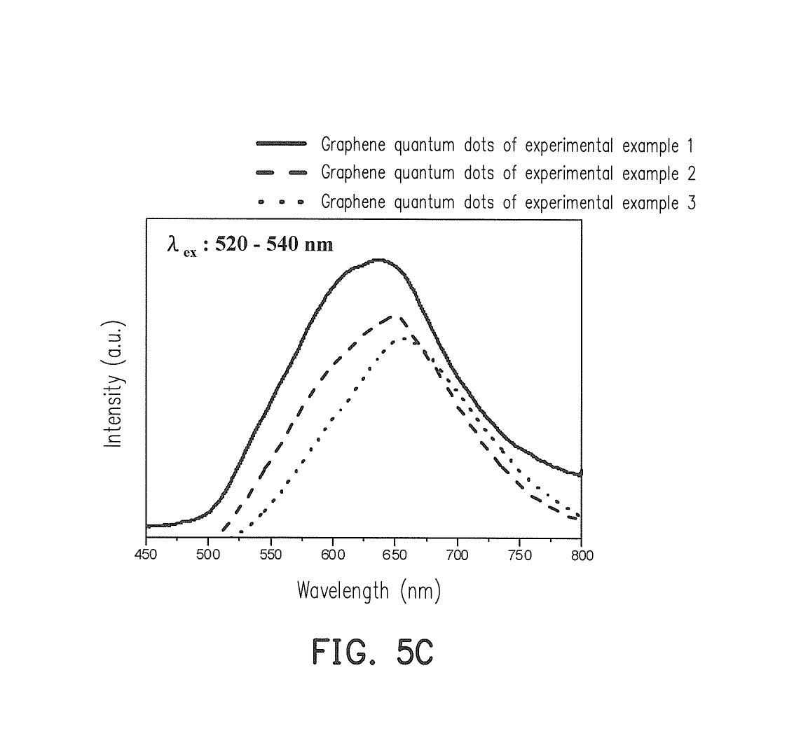

FIG. 5A to FIG. 5C are fluorescence spectrograms of the graphene quantum dot powders of experimental examples 1, 2, and 3 under excitation lights of different wavelengths. Using the graphene quantum dot powder of experimental example 1 as an example, with different excitation wavelengths (kₑₓ=360 nm to 380 nm, 460 nm to 480 nm, or 520 nm to 540 nm), the luminescence wavelength range thereof is about 450 nm (can be blue light) to 650 nm (can be red light). It can be known by combining the HR-TEM micrographs of FIG. 2A to FIG. 4B that, the photoluminescence characteristics are caused by a quantum confinement effect. Therefore, the graphene quantum dot powders prepared by the above fabrication method have particle sizes and photoluminescence properties similar to the quantum dots.

### EXPERIMENTAL EXAMPLE 4

### Fabrication of Graphene Quantum Dot Thin Film

First, a graphene quantum dot solution was prepared with the same method as comparative example 1. Then, the graphene quantum dot solution of comparative example 1 was diluted 50 folds with double distilled water, and then 4 mL was taken and placed into a round plastic box having a diameter of 4 cm and a height of 1 cm. A glass substrate (length: 1.8 cm, width: 1.8 cm) was parallelly immersed in the aqueous solution. The surface of the glass substrate on which a film was to be grown was placed face up and complete immersion of the surface in the solution was confirmed. After covering with a lid, the substrate was left in an incubator at 30° C. for 12 hours, and a thin film of graphene quantum dots was formed on the surface of the glass substrate facing up. The prepared thin film was further dried in an oven at 60° C. for 60 minutes, and the graphene quantum dot thin film of experimental example 4 was obtained. Blue light (450 nm to 475 nm) was emitted upon irradiation of an ultraviolet lamp (360 nm to 380 nm).

### EXPERIMENTAL EXAMPLE 5

### Fabrication of Graphene Quantum Dot Thin Film

First, a graphene quantum dot thin film was prepared with the same method as experimental example 4. Then, the graphene quantum dot thin film of experimental example 4 was placed in a lidless quartz crucible and calcinated with a high-temperature calcination furnace at 300° C. for 10 minutes. After being cooled at room temperature, the graphene quantum dot thin film of experimental example 5 was obtained. Green light (525 nm to 550 nm) was emitted upon irradiation of an ultraviolet lamp (360 nm to 380 nm).

### EXPERIMENTAL EXAMPLE 6

### Fabrication of Graphene Quantum Dot Thin Film

First, a graphene quantum dot thin film was prepared with the same method as experimental example 4. Then, the graphene quantum dot thin film of experimental example 4 was placed in a lidless quartz crucible and calcinated with a high-temperature calcination furnace at 300° C. for 20 minutes. After being cooled at room temperature, the graphene quantum dot thin film of experimental example 6 was obtained. Yellow light (570 nm to 590 nm) was emitted upon irradiation of an ultraviolet lamp (360 nm to 380 nm).

The graphene quantum dot thin films of experimental examples 4, 5, and 6 were set up with different excitation light sources (such as 360 nm, 460 nm, and 520 nm), wherein the three graphene quantum dot thin films can yield at least 7 photoluminescence combinations (such as red, khaki, light yellow, olivine, green, light green, and blue). Therefore, the invention can be applied in an optical display, a white LED, and stained glass.

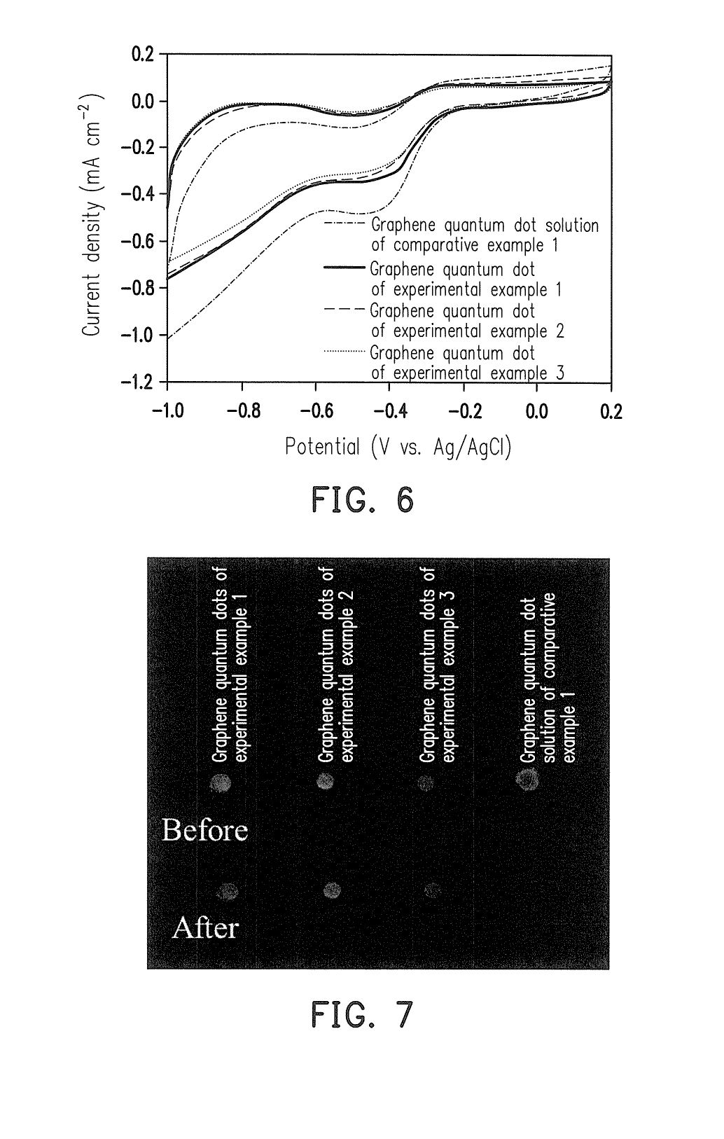

FIG. 6 is a relationship diagram of current density-potential variation of the graphene quantum dot powders of experimental examples 1 to 3 and the fluorescent graphene quantum dot solution of comparative example 1 measured by cyclic voltammetry (CV). In a solution of 0.5 M KOH and 0.5 M CH₃OH purged by oxygen, measurement of CV was performed on each electrode containing the graphene quantum dot powders of experimental examples 1 to 3 and the fluorescent graphene quantum dot solution of comparative example 1, and the relationship between current density and potential variation thereof is as shown in FIG. 6. It can be known from FIG. 6 that, after CV measurement in a methanol solution, the electrodes containing the graphene quantum dot powders of experimental examples 1 to 3 still have the signal of redox. In other words, an oxidation reaction is not performed on methanol by the graphene quantum dot powders of experimental examples 1 to 3. Therefore, the graphene quantum dot powders of experimental examples 1 to 3 can be used as the cathode material of a fuel cell.

Moreover, referring to FIG. 7, after a potential scan is performed on each electrode containing the graphene quantum dot powders of experimental examples 1 to 3 with 500 cycles of CV, the reduction of the activity of redox thereof is less than 3% and peeling does not occur to the electrode. In comparison, after a potential scan is performed on the electrode containing the fluorescent graphene quantum dot solution of comparative example 1 with 200 cycles of CV, the reduction of the activity of redox thereof is greater than 30% and peeling occurs to the electrode. This indicates that the graphene quantum dot powders of experimental examples 1 to 3 have better stability than the fluorescent graphene quantum dot solution of comparative example 1.

It should also be mentioned that, the graphene quantum dot thin films of experimental examples 4 to 6 can be used as lithography materials. For instance, writing is performed on the graphene quantum dot thin film of experimental example 5 with near-infrared laser, and a specific text or pattern can be carved. Under the irradiation of a UV lamp, the graphene quantum dot thin film irradiated by near-infrared laser (can be viewed as a further heat treatment) renders green luminescence.

Based on the above, the invention provides a fabrication method combining a hydrothermal method and a heating method to synthesize a graphene quantum dot powder or thin film for which luminescence wavelength can be regulated. The fabrication method has the advantages of safe operation, fast and easy, low toxicity, environmentally-friendly, simple setup, and safe, low-cost, and readily obtainable raw materials. The graphene quantum dot powder or thin film obtained thereby has superior characteristics in, for instance, luminescence intensity, regulative luminescence qualities, good optical and chemical stability, catalysis, and ready modification on a glass substrate. As a result, the nano composite material powder or thin film can be applied in an optical display (such as a white light LED), lithography, the cathode material of a fuel cell, and stained glass.

Although the invention has been described with reference to the above embodiments, it will be apparent to one of the ordinary skill in the art that modifications to the described embodiments may be made without departing from the spirit of the invention. Accordingly, the scope of the invention is defined by the attached claims not by the above detailed descriptions.

What is claimed is:

1. A photoluminescent nano composite material, comprising:
a plurality of silicon oxide clusters; and
a plurality of carbon nanostructures embedded in the silicon oxide clusters, wherein the carbon nanostructures generate an emitted light upon irradiation of an excitation light source.

2. The photoluminescent nano composite material of claim 1, wherein a size of the carbon nanostructures is 6.5 nm to 7.7 nm.

3. The photoluminescent nano composite material of claim 1, wherein a wavelength range of the excitation light source is 360 nm to 520 nm and a wavelength range of the emitted light is 455 nm to 637 nm.

4. The photoluminescent nano composite material of claim 1, wherein a size of the carbon nanostructures is 12.4 nm to 14 nm.

5. The photoluminescent nano composite material of claim 1, wherein a wavelength range of the excitation light source is 360 nm to 520 nm and a wavelength range of the emitted light is 534 nm to 645 nm.

6. The photoluminescent nano composite material of claim 1, wherein a size of the carbon nanostructures is 25 nm to 31 nm.

7. The photoluminescent nano composite material of claim 1, wherein a wavelength range of the excitation light source is 360 nm to 520 nm and a wavelength range of the emitted light is 574 nm to 659 nm.

8. The photoluminescent nano composite material of claim 1, wherein the carbon nanostructures comprise graphene quantum dots.

9. A method of fabricating a photoluminescent nano composite material, comprising:
(A) providing an organosilane solution;
(B) performing a first heat treatment on the organosilane solution with a hydrothermal method to form a nano composite material precursor solution; and
(C) performing a hydrolysis condensation reaction and a drying treatment on the nano composite material precursor solution to form a first nano composite material powder.

10. The method of claim 9, wherein steps of the hydrolysis condensation reaction comprise:
diluting the nano composite material precursor solution 45 folds to 50 folds with double distilled water and then leaving the solution in an incubator at 30° C. to 35° C. for 12 hours to 14 hours.

11. The method of claim 9, further comprising, after step (C), (D) performing a second heat treatment on the first nano composite material powder to form a second nano composite material powder.

12. The method of claim 11, wherein a temperature of the second heat treatment is 300° C. to 322° C. and a heating time of the second heat treatment is 10 minutes to 12 minutes.

13. The method of claim 11, wherein a temperature of the second heat treatment is 300° C. to 322° C. and a heating time of the second heat treatment is 20 minutes to 22 minutes.

14. The method of claim 9, wherein the organosilane solution comprises: an aqueous solution of 3-aminopropyl trimethoxysilane or an aqueous solution of 3-aminopropyl triethoxysilane.

15. The method of claim 9, wherein a temperature of the first heat treatment is 300° C. to 310° C. and a heating time of the first heat treatment is 2 hours to 2.15 hours.

16. A method of fabricating a photoluminescent nano composite material, comprising:
(A) providing an organosilane solution;
(B) performing a first heat treatment on the organosilane solution with a hydrothermal method to form a nano composite material precursor solution;
(C) placing a substrate in the nano composite material precursor solution such that a hydrolysis condensation reaction is performed on a surface of the substrate by the nano composite material precursor solution and a thin film is formed on the surface of the substrate; and
(D) performing a drying treatment on the thin film to form a first nano composite material thin film.

17. The method of claim 16, wherein steps of the hydrolysis condensation reaction comprise:
diluting the nano composite material precursor solution 45 folds to 50 folds with double distilled water;
placing a substrate in the nano composite material precursor solution, wherein the surface of the substrate on which a film is to be grown is faced up; and
leaving the substrate in an incubator at 30° C. to 35° C. for 12 hours to 14 hours such that the thin film is formed on the surface of the substrate.

18. The method of claim 16, further comprising, after step (D), (E) performing a second heat treatment on the first nano composite material thin film to form a second nano composite material thin film.

19. The method of claim 18, wherein a temperature of the second heat treatment is 300° C. to 322° C. and a heating time of the second heat treatment is 10 minutes to 12 minutes.

20. The method of claim 18, wherein a temperature of the second heat treatment is 300° C. to 322° C. and a heating time of the second heat treatment is 20 minutes to 22 minutes.

21. The method of claim 16, wherein the organosilane solution comprises: an aqueous solution of 3-aminopropyl trimethoxysilane or an aqueous solution of 3-aminopropyl triethoxysilane.

22. The method of claim 16, wherein a temperature of the first heat treatment is 300° C. to 310° C. and a heating time of the first heat treatment is 2 hours to 2.15 hours.
